(19) United States
(12) Patent Application Publication
(10) Pub. No.: US 2026/0010423 A1
(43) Pub. Date: Jan. 8, 2026

(54) METHOD AND APPARATUS FOR REPORTING ASSET INFORMATION, STORAGE MEDIUM, AND ELECTRONIC DEVICE

(71) Applicant: SUZHOU METABRAIN INTELLIGENT TECHNOLOGY CO., LTD., Suzhou, Jiangsu (CN)

(72) Inventor: Haimeng WANG, Suzhou, Jiangsu (CN)

(73) Assignee: SUZHOU METABRAIN INTELLIGENT TECHNOLOGY CO., LTD., Suzhou, Jiangsu (CN)

(21) Appl. No.: 19/122,949

(22) PCT Filed: Jan. 4, 2024
(86) PCT No.: PCT/CN2024/070672

§ 371 Date: Apr. 21, 2025

(30) Foreign Application Priority Data
Jun. 27, 2023 (CN) 202310767751.5

(51) Int. Cl. G06F 11/07; G06F 9/4401; G06F 13/42

(52) U.S. Cl. CPC G06F 11/073; G06F 9/4401; G06F 11/079; G06F 13/4282; G06F 2213/0026

(57) ABSTRACT

Embodiments of the present disclosure provide a method and apparatus for reporting asset information, a non-transitory computer readable storage medium, and an electronic device. The method for reporting asset information includes: reading, in a case where a target device supports memory expansion, Serial Presence Detect (SPD) information of a designated memory bank mounted to the target device from a configuration space register of a Memory Expander Controller (MXC) of the target device by means of a Basic Input Output System (BIOS), wherein the target device is a device that supports a Computer Express Link (CXL) protocol, which is an open interconnection standard; and reporting, in a case where target SPD information has been read, the target SPD information to a Central Processing Unit (CPU) of the target device as system asset information by means of the BIOS.

### CROSS-REFERENCE TO RELATED APPLICATION

The present application claims priority to Chinese Patent Application No. 202310767751.5, filed to the China National Intellectual Property Administration on Jun. 27, 2023 and entitled “Method and Apparatus for Reporting Asset Information, Storage Medium, and Electronic Device”, the disclosure of which is hereby incorporated by reference in its entirety.

### TECHNICAL FIELD

Embodiments of the present disclosure relate to the field of computers, and in particular, to a method and apparatus for reporting asset information, a non-transitory readable storage medium, and an electronic device.

### BACKGROUND

In related art, a Computer Express Link (CXL) (a new open interconnection standard) protocol may effectively solve the problem of cache coherence among a Central Processing Unit (CPU), a memory expansion, and an accelerator, thereby reducing the number of copies of data between different devices and saving the memory space.

However, a system in which a CXL device is introduced cannot directly use a traditional Inter-Integrated Circuit (I2C) (a synchronous and half-duplex communication bus) line to read a Serial Presence Detect (SPD) area of Dual-Inline-Memory-Modules (DIMM) (a memory bank). After a Memory Expander Controller (MXC) chip accesses SPD information of the DIMM by means of an I2C, a Baseboard Management Controller (BMC), which is connected to the MXC chip through the I2C line, needs to first acquire the SPD information from the MXC, and then a Basic Input Output System (BIOS) acquires the SPD information from the BMC by means of an Intelligent Platform Management Interface (IPMI) command to complete the reporting of asset information of the DIMM.

### SUMMARY

According to a first aspect of embodiments of the present disclosure, a method for reporting asset information is provided, which includes: reading, in a case where a target device supports memory expansion, SPD information of a designated memory bank mounted to the target device from a configuration space register of an MXC of the target device by means of a BIOS, where the target device is a device that supports a CXL protocol, which is an open interconnection standard; and reporting, in a case where target SPD information has been read, the target SPD information to a CPU of the target device as system asset information by means of the BIOS.

According to a second aspect of embodiments of the present disclosure, an apparatus for reporting asset information is provided, which includes: a first reading unit, configured to read, in a case where a target device supports memory expansion, SPD information of a designated memory bank mounted to the target device from a configuration space register of an MXC of the target device by means of a BIOS, where the target device is a device that supports a CXL protocol, which is an open interconnection standard; and a reporting unit, configured to report, in a case where target SPD information has been read, the target SPD information to a CPU of the target device as system asset information by means of the BIOS.

According to a third aspect of embodiments of the present disclosure, a computer non-transitory readable storage medium is further provided, in which a computer program is stored. The computer program is configured to execute steps in any one of the above method embodiments when running.

According to a fourth aspect of embodiments of the present disclosure, an electronic device is further provided, which includes a memory and a processor. A computer program is stored in the memory, and the processor is configured to run the computer program to execute steps in any one of the above method embodiments.

### BRIEF DESCRIPTION OF THE DRAWINGS

FIG. 1 is a schematic diagram of a hardware environment of a method for reporting asset information according to embodiments of the present disclosure.

FIG. 2 is a flowchart of a method for reporting asset information according to embodiments of the present disclosure.

FIG. 3 is a schematic diagram of a method for reporting asset information according to embodiments of the present disclosure.

FIG. 4 is a schematic diagram of another method for reporting asset information according to embodiments of the present disclosure.

FIG. 5 is a schematic diagram of still another method for reporting asset information according to embodiments of the present disclosure.

FIG. 6 is a schematic diagram of still another method for reporting asset information according to embodiments of the present disclosure.

FIG. 7 is a flowchart of another method for reporting asset information according to embodiments of the present disclosure.

FIG. 8 is a structural block diagram of an apparatus for reporting asset information according to embodiments of the present disclosure.

### DETAILED DESCRIPTION OF THE EMBODIMENTS

Embodiments of the present disclosure are described below with reference to the drawings and in conjunction with the embodiments in detail.

It is to be noted that terms “first”, “second” and the like in the specification, claims and the above drawings of the embodiments of the present disclosure are used for distinguishing similar objects rather than describing a specific sequence or a precedence order.

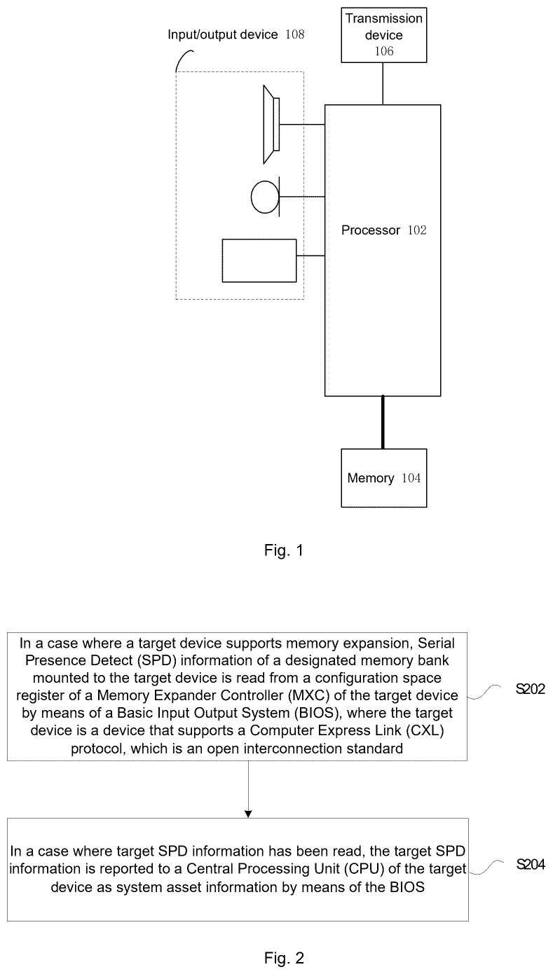

The method embodiment provided by the embodiments of the present disclosure may be implemented in a mobile terminal, a computer terminal or a similar computing apparatus. Taking running on the computer terminal as an example, FIG. 1 is a schematic diagram of a hardware environment of a method for reporting asset information according to embodiments of the present disclosure. As shown in FIG. 1, the computer terminal may include one or more (only one is shown in FIG. 1) processors 102 (the processors 102 may include, but are not limited to, a Micro Processor Unit (MCU) or a Field Programmable Gate Array (FPGA), and other processing apparatuses), and a memory 104 configured to store data. The above computer terminal may further include a transmission device 106 with a communication function and an input/output device 108. Those of ordinary skill in the art may understand that the structure shown in FIG. 1 is only schematic and not intended to limit the structure of the above computer terminal. For example, the computer terminal may further include more or fewer components than shown in FIG. 1, or has a different configuration from that shown in FIG. 1.

The memory 104 may be configured to store a computer program, for example, a software program or a module of application software, such as a computer program corresponding to a method for reporting asset information in the embodiments of the present disclosure. The processor 102 runs the computer program stored in the memory 104 to perform various functional applications and data processing, that is, to implement the above method. The memory 104 may include a high speed Random Access Memory (RAM) and may further include a non-volatile memory such as one or more magnetic storage apparatuses, a flash memory, or other non-volatile solid state memories. In some examples, the memory 104 includes memories remotely located relative to the processor 102, which may be connected to the mobile terminal over a network. Examples of the above network include, but are not limited to, the Internet, the Intranet, a local area network, a mobile communication network, and a combination thereof.

The transmission module 106 is configured to receive or transmit data through a network. The examples of the above network may include a wireless network provided by a communication provider of the computer terminal. In one example, the transmission device 106 includes a Network Interface Controller (NIC) that may be connected to other network devices through a base station to communicate with the Internet. In one example, the transmission device 106 may be a Radio Frequency (RF) module, which is configured to communicate with the Internet in a wireless manner.

According to one aspect of the embodiments of the present disclosure, a method for reporting asset information is provided. Taking the method for reporting asset information in the embodiments of the present disclosure executed by a computer terminal as an example, FIG. 2 is a flowchart of a method for reporting asset information according to embodiments of the present disclosure. As shown in FIG. 2, the flow includes the following steps.

At S202, in a case where a target device supports memory expansion, SPD information of a designated memory bank mounted to the target device is read from a configuration space register of an MXC of the target device by means of a BIOS, where the target device is a device that supports a CXL protocol, which is an open interconnection standard.

The method for reporting asset information in the embodiments of the present disclosure may be applied to a scenario where the asset information of the designated memory bank in a CXL device is reported. The CXL device may be a device that supports the CXL protocol. The CXL protocol allows a memory of a CPU and a memory of an attached device to maintain consistency. The designated memory bank in the CXL device may be a DIMM mounted to the CXL device. Correspondingly, the asset information of the designated memory bank may be the SPD information of the DIMM, including, but is not limited to, a memory chip and module manufacturer, an operating frequency, an operating voltage, a speed, a capacity, a voltage, row and column address bandwidths, and other parameters.

For an ordinary system in which the CXL protocol is not introduced, a flow for reporting asset information of the DIMM is mainly that the system is powered on, the CPU is selected by a Platform Controller Hub (PCH) (an integrated south bridge chip) through a Multiplexer (MUX), and accesses the DIMM by an I2C to acquire the SPD information. When the CXL device is introduced in the system, the DIMM mounted thereto is visible to the system and may be introduced in the address space of the system. However, a path from the CPU to a CXL memory is CXL, which is a composite bus based on a Peripheral Component Interconnect express (PCI-Express, i.e. PCIe) (a high-speed serial computer expansion bus standard) Physical (Phy) layer link. The manner of acquiring the asset information of the DIMM for the system in which the CXL protocol is introduced requires a BMC to connect to an MXC chip through the I2C, and the MXC accesses the SPD information of the DIMM through the I2C. After the BMC acquires the asset information, the BIOS may obtain the corresponding SPD information from the BMC by means of an IPMI command. However, although the method may acquire the accurate SPD information, it involves out-of-band access, which is not direct enough for the BIOS, and the efficiency of acquiring the asset information is also relatively low.

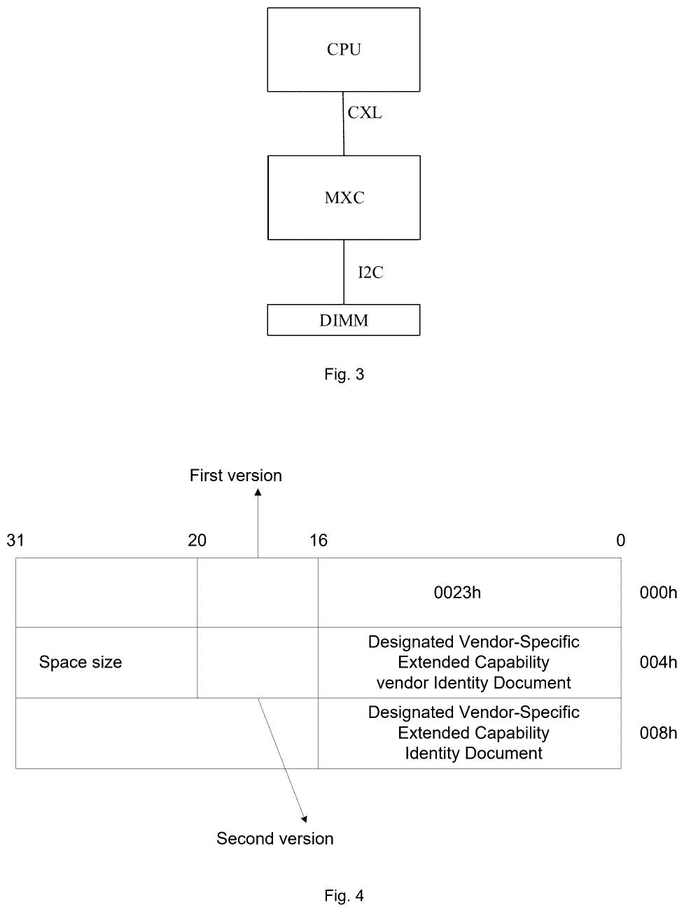

In order to at least solve some of the above problems, considering that the MXC and the CPU are connected through the CXL/PCIe, a PCIe protocol stipulates that a PCIe device may allow a host/CPU to access some of its configuration information in a memory map manner. For the SPD information of the DIMM mounted to the CXL device, the SPD information may also be accessed in the same manner. For example, by customizing a set of PCIe extended capability registers and storing the SPD information in the custom registers, the BIOS may directly access the SPD information in a memory map manner, as shown in FIG. 3, without the need for out-of-band access.

Considering that the SPD information only exists in a storage device, for a device without memory expansion capability, there is no need to read the SPD information. In embodiments of the present disclosure, in a case where it is determined that the target device supports memory expansion, a reading operation of the corresponding SPD information may be performed on the target device. The reading operation of the SPD information may be performed by directly reading the SPD information of the designated memory bank mounted to the target device from the configuration space register of the MXC of the target device by means of the BIOS. Here, the target device may be a device that supports the CXL protocol, which is the open interconnection standard, i.e., the CXL device. The MXC and the designated memory bank may be connected through the I2C. The configuration space register of the MXC may refer to the configuration space register in the MXC that is only configured to store the SPD information, which may be a register or a group of registers.

At S204, in a case where target SPD information has been read, the target SPD information is reported to the CPU of the target device as system asset information by means of the BIOS.

In a case where the read SPD information of the designated memory bank is determined to be the target SPD information of the target device, the target SPD information may be directly reported to the CPU of the target device as the system asset information by means of the BIOS. The reporting manner may be that the read target SPD information is added to a data table structure that records the system asset information to complete the reporting of the system asset information, or the target SPD information is directly sent to the CPU, which is not limited in the embodiments of the present disclosure.

Through the above steps, by means of the embodiments of the present disclosure, the SPD information of the designated memory bank is stored in the configuration space register of the MXC, and in a case where the target device supports memory expansion, the SPD information of the designated memory bank mounted to the target device is read from the configuration space register of the MXC of the target device by means of the BIOS, where the target device is a device that supports the CXL protocol, which is the open interconnection standard; and in a case where the target SPD information has been read, the target SPD information is reported to the CPU of the target device as the system asset information by means of the BIOS. Since the information stored in the configuration space register may be directly accessed by the BIOS without being indirectly acquired by means of the BMC, the purpose of acquiring the asset information only by means of in-band access may be achieved, thereby solving the problem of low reporting efficiency of the asset information due to out-of-band access in the method for reporting asset information in the related art and achieving the technical effect of improving the reporting efficiency of the asset information.

In some embodiments of the present disclosure, the operation of reporting, in a case where the target SPD information has been read, the target SPD information to the CPU of the target device as the system asset information by means of the BIOS includes: adding, in a case where the SPD information has been read, the target SPD information to a designated data structure of the BIOS by means of the BIOS, so as to report the target SPD information to the CPU of the target device as the system asset information of the BIOS, where the designated data structure is a data structure for reporting the system asset information.

Considering a computer that complies with the System Management Basic Input/Output System (SMBIOS) specification, the system asset information may be obtained by accessing the structure of the SMBIOS, that is, based on a method of the table structure, a type structure table corresponding to the system asset information is found, and then the corresponding system asset information is acquired. Therefore, in the embodiments of the present disclosure, the operation of reporting the target SPD information to the CPU of the target device as the system asset information may be completed by adding the target SPD information to the designated data structure of the BIOS by means of the BIOS.

The above designated data structure may be the data structure for reporting the system asset information, such as a data table structure for recording the storage device, i.e., Smbios type17 (a data table structure in the SMBIOS).

Through the embodiments of the present disclosure, by adding the target SPD information to the designated data structure to complete the reporting of the system asset information, the simplicity of information reporting may be improved.

In some embodiments of the present disclosure, the operation of reading, in a case where the target device supports memory expansion, the SPD information of the designated memory bank mounted to the target from the configuration space register of the MXC of the target device by means of the BIOS includes: accessing, in a case where the target device supports memory expansion, the configuration space register of the MXC by the BIOS in a memory map manner, so as to read the SPD information of the designated memory bank mounted to the target device from the configuration space register of the MXC.

The MXC of the target device may have a plurality of configuration space registers to respectively store configuration information corresponding to the target device and the SPD information of the designated memory bank of the target device. The manner of acquiring the information stored in the configuration space register may be memory map.

By means of the memory map manner, the configuration space register corresponding to information to be acquired may be directly determined according to a mapping relationship between the information to be acquired and the configuration space register, then the configuration space register may be accessed, and the information to be acquired may be read from the configuration space register.

In the embodiments of the present disclosure, the reading of the SPD information may be the same as the aforementioned manner of reading the information to be acquired. The configuration space register of the MXC of the target device may be accessed by the BIOS in a memory map manner, so as to read the SPD information of the designated memory bank from the configuration space register of the MXC.

Through the embodiments of the present disclosure, the reading of SPD information is completed in a manner map manner, which may improve the efficiency of information acquisition.

In some embodiments of the present disclosure, before reading, in a case where the target device supports memory expansion, the SPD information of the designated memory bank mounted to the target from the configuration space register of the MXC of the target device by means of the BIOS, the above method further includes: reading, after the MXC is powered on, the SPD information of the designated memory bank mounted to the target device by means of the MXC; and writing the read SPD information of the designated memory bank into the configuration space register of the MXC.

In order to avoid data delay, in the embodiments of the present disclosure, the SPD information of the designated memory bank may be written into the configuration space register of the MXC immediately after the MXC is powered on. That is, after the MXC is powered on, the SPD information of the designated memory bank mounted to the target device may be read by means of the MXC, and the read SPD information of the designated memory bank may be written into the configuration space register of the MXC, so that the BIOS may access the corresponding information (including the SPD information) of the target device in time when the BIOS is started. The result of writing may be successful or failed.

Since the MXC may read the SPD information immediately after being powered on and fill the SPD information into its own configuration space register, the BIOS cannot start reading the SPD information until the CPU is powered on, and the MXC is powered on before the CPU is powered on, when the BIOS needs the SPD information, the MXC is likely to have prepared the SPD information, thereby reducing the possibility of data delay.

Through the embodiments of the present disclosure, the MXC starts reading and writing the SPD information after being powered on, which may effectively reduce the possibility of data delay and improve the efficiency of the BIOS in acquiring the SPD information.

In some embodiments of the present disclosure, the configuration space register of the MXC is a Designated Vendor-Specific Extended Capability (DVSEC) register. The operation of writing the read SPD information of the designated memory bank into the configuration space register of the MXC includes: writing the read SPD information of the designated memory bank into one DVSEC register, where the space size of the DVSEC register is a designated space size; or respectively writing sub-SPD information read from each data block in a plurality of data blocks into one DVSEC register, where the SPD information of the designated memory bank is divided into a plurality of pieces of sub-SPD information, and each piece of sub-SPD information in the plurality of pieces of sub-SPD information is respectively stored in each data block in the plurality of data blocks.

The configuration space register may be the DVSEC register, and the operation of writing the read SPD information of the designated memory bank into the configuration space register of the MXC may refer to an operation of writing the read SPD information into the DVSEC space. As shown in FIG. 4, the first version (capability version) may be configured to indicate a capability (a structure) version. The second version (dvsec revision) is a vendor-specific version number, which is configured to indicate the version of a DVSEC structure. The DVSEC space size (DVSEC Length: 0x400) may be designated in a DVSEC header, and a DVSEC vendor Identity Document (ID) may be configured as a fixed value corresponding to a device type. Different DVSEC space may be distinguished by setting different DVSEC IDs. The device type here may be a device with memory expansion capability and a device without memory expansion capability, which are distinguished according to whether the device has memory expansion capability.

In the embodiments of the present disclosure, the read SPD information of the designated memory bank may be written into one DVSEC register. The space size of the DVSEC register may be the designated space size, i.e., the size of the SPD information of the DIMM. Taking the SPD information of DIMM Double Data Rate Synchronous Dynamic Random Access Memory (DDR SDRAM 5) (DDR5) (which is a fifth-generation memory bank) as an example, the SPD information is 1 KB, and the corresponding DVSEC space size is 1 KB.

Considering that the target device may be a block device, the corresponding SPD information of the DIMM may be divided into the plurality of pieces of sub-SPD information, each piece of sub-SPD information of the plurality of pieces of sub-SPD information is stored in each data block in the plurality of data blocks, and correspondingly, the format of the SPD information may be as shown in Table 1.

TABLE 1

| Block | Range | | Description |
|---|---|---|---|
| 0 | 0-63 | 0x000-0x03F | Base Configuration and |
| | | | DRAM Parameters |
| 1 | 64-127 | 0x000-0x03F | Base Configuration and |
| | | | DRAM Parameters |
| 2 | 128-191 | 0x040~0x07F | Reserved for future use |
| 3 | 192-239 | 0x080~0x0BF | Common Module Parameters - |
| | | | See annex A.O for details |
| 4 | 240-255 | 0x0C0-0X0EF | Standard Module Parameters - |
| | | | See annexes A.x for details |
| 5 | 256-319 | 0x0D0-0x0FF | Standard Module Parameters - |
| | | | See annexes A.x for details |
| 6 | 320-383 | 0x100-0x13F | Standard Module Parameters - |
| | | | See annexes A.x for details |
| 7 | 384-447 | 0x140-0x17F | Standard Module Parameters - |
| | | | See annexes A.x for details |
| 8 | 448-509 | 0x180~0x1BF | Reserved for future use |
| 9 | 510-511 | 0x1C0~0x1FD | CRC for sPD bytes 0-509 |
| 10 | 512-575 | 0x1FE-0x1FF | Manufacturing information |
| 11 | 576-639 | 0x200-0x23F | Manufacturing information |
| 12 | 640-703 | 0x240-0x27F | End User Programmable |
| 13 | 704-767 | 0x280-0x2BF | End User Programmable |
| 14 | 768-831 | 0x2C0-0x2FF | End User Programmable |
| 15 | 832-895 | 0x300-0x33F | End User Programmable |

In the embodiments of the present disclosure, in a case where the SPD information is divided into the plurality of pieces of sub-SPD information, the sub-SPD information read from each data block of the plurality of data blocks may be written into one DVSEC register. Correspondingly, one DVSEC ID may be applied for each data block, respectively corresponding to each DVSEC register.

Through the embodiments of the present disclosure, the SPD information is written in different writing manners, so that the efficiency of writing the SPD information into the configuration space register may be improved.

In some embodiments of the present disclosure, before respectively writing the sub-SPD information read from each data block in the plurality of data blocks into one DVSEC register, the method further includes: setting the corresponding DVSEC register for each data block according to the space size of each data block, where the space size of the corresponding DVSEC register set for each data block is greater than or equal to the space size of each data block.

In a case where the sub-SPD information is respectively stored in the plurality of data blocks, in the embodiments of the present disclosure, the corresponding DVSEC register may be set for each data block according to the space size of each data block. The space size of the set DVSEC register may be greater than or equal to the space size of the corresponding data block.

The above data block may be the aforementioned block, and the size of each block may be different. Correspondingly, the space size of each DVSEC register (i.e., DVSEC Length) may also be different.

Through the embodiments of the present disclosure, the space size of the corresponding register is set according to the size of each data block, so that the storage utilization rate of the register may be improved.

In some embodiments of the present disclosure, before respectively writing the sub-SPD information read from each data block in the plurality of data blocks into one DVSEC register, the method further includes: numbering each data block in the plurality of data blocks; and setting a corresponding register identifier for each data block, where the register identifier corresponding to each data block includes: a first register identifier for identifying a register vendor of the DVSEC register corresponding to each data block, and a second register identifier for identifying the DVSEC register corresponding to each data block, where some identifiers in the second register identifier corresponding to each data block are matched with a number of each data block.

In a case where the sub-SPD information is respectively stored in the plurality of data blocks, in order to improve the efficiency of filling the read sub-SPD information into the DVSEC register and avoid filling the sub-SPD information read from one data block into the DVSEC register corresponding to other data blocks, in the embodiments of the present disclosure, each data block in the plurality of data blocks may be numbered and the corresponding register identifier may be set for each data block according to the number.

The above register identifier corresponding to each data block may include: the first register identifier (i.e., DVSEC vendor ID) for identifying the register vendor of the DVSEC register corresponding to each data block, and the second register identifier (i.e., DVSEC ID) for identifying the DVSEC register corresponding to each data block. Some identifiers in the second register identifier corresponding to each data block are matched with the number of each data block.

For example, the DVSEC vendor ID of the DVSEC register may be set to 1E98 according to the CXL protocol. As for the DVSEC ID of the DVSEC register, since the DVSEC ID occupied by the current CXL official regulations is: 0-A(1010 (bit)), bit(4) may be used as an identification bit, that is, it may correspond to the data block starting from (10000). Since the SPD information may correspond to a total of 16 blocks, the 16 blocks may be numbered 0 to 15 as shown in Table 1,then the DVSEC IDs of the 16 DVSEC registers may start from (10000) and be set to (10000-11111). When the read sub-SPD information needs to be filled into one DVSEC register, the corresponding DVSEC register may be selected by using some bits in the DVSEC ID of each register that correspond to the data block identifier.

Through the embodiments of the present disclosure, the DVSEC register storing the sub-SPD information of different data blocks is distinguished by means of the second register identifier, so that the efficiency of filling the SPD information into the DVSEC register may be improved.

In some embodiments of the present disclosure, after reading the SPD information of the designated memory bank mounted to the target device by means of the MXC, the above method further includes: determining a first hash value corresponding to the read SPD information of the designated memory bank; and comparing the first hash value with a second hash value corresponding to the SPD information recorded in the configuration space register of the MXC, where the read SPD information of the designated memory bank is written into the configuration space register of the MXC in a case where the first hash value and the second hash value are inconsistent.

In order to avoid repeatedly reading and writing the same SPD information each time the MXC is powered on, in the embodiments of the present disclosure, the corresponding hash value may be generated for the SPD information read each time and the hash value may be saved. When the MXC is powered on and reads the SPD information, the hash value of the currently read SPD information may be compared with the saved hash value. In response to the current hash value being different from the saved hash value, it is saved in the configuration space register.

After reading the SPD information of the designated memory bank mounted to the target device by means of the MXC, the first hash value corresponding to the read SPD information of the designated memory bank may be first determined, the first hash value is compared with the second hash value corresponding to the SPD information recorded in the configuration space register of the MXC, and the read SPD information of the designated memory bank is written into the configuration space register of the MXC in a case where the first hash value and the second hash value are inconsistent.

Through the embodiments of the present disclosure, by recording the hash value of the SPD information read each time, repeated writing of the same SPD information may be avoided.

In some embodiments, before reading, in a case where the target device supports memory expansion, the SPD information of the designated memory bank mounted to the target device from the configuration space register of the MXC of the target device by means of the BIOS, the method further includes: reading memory expansion indication information from a specific configuration space register of the MXC of the target device by means of the BIOS, where the specific configuration space register is a configuration space register that records a device type of the target device, and the memory expansion indication information is configured to indicate whether the target device supports memory expansion; and determining, in a case where the memory expansion indication information indicates that the target device supports memory expansion, that the target device supports memory expansion. In a case where the memory expansion indication information indicates that the target device does not support memory expansion, it is determined that the target device has no SPD information.

Considering the presence of a device that does not support memory expansion, in some embodiments of the present disclosure, after the system is powered on, the memory expansion indication information may be read from the specific configuration space register of the MXC of the target device by means of the BIOS. In a case where the memory expansion indication information indicates that the target device supports memory expansion, it is determined that the target device supports memory expansion, and related operations such as reading and writing the SPD information are performed according to the description of the aforementioned embodiments.

The above specific configuration space register may be the configuration space register that records the device type of the target device, or may be the configuration space register that only records the device type of the target device, and may be the same as or different from the type of the aforementioned configuration space register, which is not limited in the embodiments of the present disclosure. The above memory expansion indication information may be configured to indicate whether the target device supports memory expansion.

In a case where the memory expansion indication information indicates that the target device does not support memory expansion, it may be determined that the target device has no SPD information, and the related operations such as reading and writing the SPD information are not performed.

Through the embodiments of the present disclosure, it is determined that the device supports memory expansion by means of the read indication data in the register, and then the operations such as reading and writing the SPD information are performed, which may avoid performing the reading operation of the SPD information on a device without SPD information for a long time, thereby improving the information reading efficiency.

In some embodiments of the present disclosure, after reading the SPD information of the designated memory bank mounted to the target device from the configuration space register of the MXC of the target device by means of the BIOS, the above method further includes: starting a timer in a case where the SPD information is not read, where a timing time of the timer is a preset time interval between two adjacent readings of the SPD information of the designated memory bank; and reading, in a case where the timing time of the timer arrives, the SPD information of the designated memory bank again from the configuration space register of the MXC by means of the BIOS.

Considering that after the CPU is powered on and the BIOS reads the SPD information from the configuration space register of the MXC, there is a possibility that the MXC does not write the read SPD information into its own configuration space register, and there is also a possibility that the reading from the configuration space register of the MXC fails. For the possible situation of the reading failure, considering that the reading may be successful after reading again, in the embodiments of the present disclosure, in a case where the SPD information is not read from the configuration space register by means of the BIOS, the SPD information may be read again by means of the BIOS after a period of time. The time interval between two adjacent readings may be preset, and the time interval may be set by the timer.

In a case where the SPD information is not read, the timer may be started, and in a case where the timing time of the timer arrives, the SPD information of the designated memory bank is read again from the configuration space register of the MXC by means of the BIOS. Here, the timing time of the timer may be the preset time interval between two adjacent readings of the SPD information of the designated memory bank.

In some embodiments of the present disclosure, in a case where the SPD information is still not read after re-reading, an error may be directly returned.

Through the embodiments of the present disclosure, when the SPD information is not read, the time of re-reading is controlled by the timer, which may avoid invalid reading in a short time and increase the possibility of successful reading.

In some embodiments of the present disclosure, before reading the SPD information of the designated memory bank mounted to the target device from the configuration space register of the MXC of the target device by means of the BIOS, the above method further includes: acquiring first bit information corresponding to the SPD information of the designated memory bank from the configuration space register of the MXC, where the first bit information is configured to identify whether the SPD information stored in the configuration space register of the MXC is valid, and the SPD information of the designated memory bank read from the configuration space register of the MXC is executed in a case where the first bit information is configured to identify that the SPD information stored in the configuration space register of the MXC is valid.

In order to avoid reading the SPD information with incorrect data, thereby causing errors in the reported system asset information, in the embodiments of the present disclosure, the corresponding first bit information may be added to the SPD information stored in the configuration space register, and the first bit information is configured to identify whether the SPD information stored in the configuration space register of the MXC is valid. For example, 1 may be used to indicate that the SPD information is valid, and 0 may be used to indicate that the SPD information is invalid. Here, whether the SPD information is valid may indicate whether the SPD information complies with the relevant provisions of a DDR SPD protocol, that is, in response to the SPD information being valid, it indicates that the SPD information complies with the relevant provisions of the DDR SPD protocol, and in response to the SPD information being invalid, it indicates that the SPD information does not comply with the relevant provisions of the DDR SPD protocol.

Before reading the SPD information of the designated memory bank mounted to the target device from the configuration space register of the MXC of the target device by means of the BIOS, the first bit information corresponding to the SPD information of the designated memory bank may be first acquired from the configuration space register of the MXC, it is determined whether the SPD information identified by the first bit information is valid, and in a case where the SPD information identified by the first bit information is valid, the operation of reading the SPD information of the designated memory bank from the configuration space register of the MXC is performed.

Through embodiments of the present disclosure, the corresponding first bit information is added to the SPD information stored in the configuration space register, so that the BIOS determines whether the SPD information is valid, which may effectively avoid reporting the erroneous asset information.

In some embodiments of the present disclosure, the designated memory bank is a group of memory banks. The method further includes: acquiring, in a case where a memory fault occurs, fault indication information corresponding to the group of memory banks from the configuration space register of the MXC, where the fault indication information corresponding to the group of memory banks is configured to indicate whether each memory bank in the group of memory banks fails; and performing fault location according to the fault indication information corresponding to the group of memory banks, so as to locate the failed memory bank in the group of memory banks.

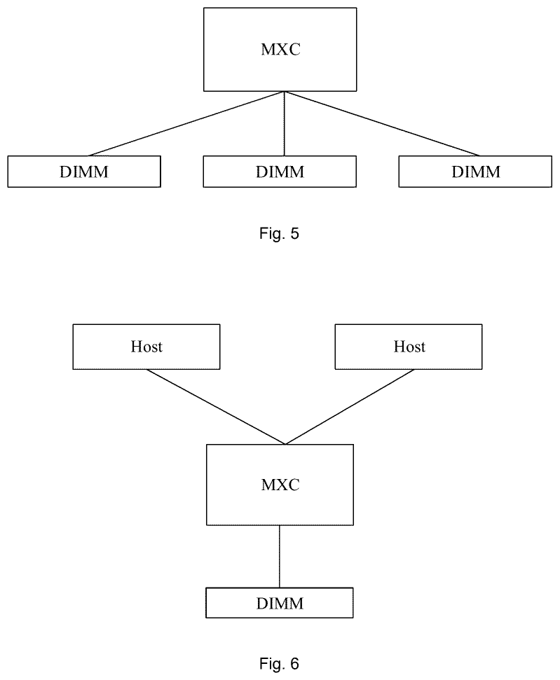

In the related art, in a case that the memory fault occurs, it can only be determined that the MXC is located. In a case that only one memory bank is mounted to the MXC, the failed memory bank may be accurately known. However, in response to a plurality of memory banks being mounted to the MXC as shown in FIG. 5, the failed memory bank cannot be accurately located.

In order to solve at least some of the above problems, in a case where the plurality of memory banks are mounted to the MXC, the above designated memory banks are a group of memory banks. In the embodiments of the present disclosure, the fault indication information corresponding to each memory bank may be written into the configuration space register of the MXC.

In a case where the memory fault occurs, the fault indication information corresponding to the group of memory banks may be acquired from the configuration space register of the MXC. Here, the fault indication information corresponding to the group of memory banks may be configured to indicate whether each memory bank in the group of memory banks fails. Fault location may be performed according to the fault indication information corresponding to the group of memory banks, so as to locate the failed memory bank in the group of memory banks.

Through the embodiments of the present disclosure, the failed memory bank is determined by means of the fault indication information in the configuration space register of the MXC, so that the accuracy of locating the memory fault may be improved.

In some embodiments of the present disclosure, the operation of acquiring, in a case where the memory fault occurs, the fault indication information corresponding to the group of memory banks from the configuration space register of the MXC includes: acquiring, in a case where the memory fault occurs, second bit information corresponding to each memory bank in the group of memory banks from the configuration space register of the MXC, where the second bit information corresponding to each memory bank is configured to indicate whether each memory bank fails.

In some embodiments of the present disclosure, the fault indication information may be represented using bits. In a case where the memory fault occurs, the second bit information corresponding to each memory bank in the group of memory banks may be acquired from the configuration space register of the MXC.

The above second bit information corresponding to each memory bank may be configured to indicate whether each memory bank fails. For a non-failed memory bank, the corresponding second bit information may be 0, and for a failed memory bank, the corresponding second bit information may be 1.

In some embodiments of the disclosure, in a case where the plurality of memory banks are mounted to the MXC, when the configuration space register is configured to store the SPD information of the memory bank, some identifiers of the configuration space register may be set as the identifiers corresponding to different memory banks. That is, the plurality of memory banks may be numbered, and some identifiers in the second register identifier of the aforementioned DVSEC register may be set as the identifiers that may indicate the numbers of different memory banks. For example, the DVSEC ID is 16 bits in total, and the first 8 bits may be configured to indicate the number of the DIMM.

For example, after finding a DIMM error, the MXC may set the corresponding bit in the corresponding configuration space register to indicate that the corresponding DIMM fails. The host polls the configuration space register of the MXC after receiving the error, and determines the corresponding DIMM according to the register identifier after reading the register with the corresponding bit as 1.

Through the embodiments of the present disclosure, in a case where the memory fault occurs, the failed memory bank is determined according to the second bit information in the configuration space register of the MXC, which may improve the accuracy of fault location.

In some embodiments of the present disclosure, the method further includes: respectively storing, in a case where the MXC is connected to a group of host-side servers, the SPD information corresponding to each host-side server in the group of host-side servers in different areas of one designated memory bank.

Considering the situation that one MXC may be connected to different hosts as shown in FIG. 6, in the embodiments of the present disclosure, in a case where the MXC is connected to the group of host-side servers, the SPD information corresponding to each host-side server in the group of host-side servers may be respectively stored in different areas of the designated memory bank.

For example, taking the single designated memory bank as an example, in a case where the MXC is connected to different hosts, the memory bank may be partitioned and allocated to different hosts.

Through the embodiments of the present disclosure, the SPD information corresponding to each host-side server in the group of host-side servers is respectively stored in different areas of the designated memory bank, so that the utilization rate of the MXC may be improved.

In some embodiments of the present disclosure, after respectively storing the SPD information corresponding to each host-side server in the group of host-side servers in different areas of one designated memory bank, the method further includes: reading, after the MXC is powered on, the SPD information of the designated memory bank mounted to the target device by means of the MXC; and updating, according to the size of different areas of the designated memory bank, the memory size in the read SPD information of the designated memory bank, and writing the updated memory size into the configuration space register of the MXC, where the memory size in the read SPD information of the designated memory bank before the update is the memory size of the designated memory bank.

In a case where the MXC only supports connection to one host, the design of the configuration space register may be performed in the manner of the aforementioned embodiments. In a case where the MXC may be connected to different hosts and the memory bank may be partitioned and allocated to different hosts, the design of the configuration space register may be optionally complex to support a multi logic device.

In some embodiments of the present disclosure, after the MXC is powered on, the SPD information of the designated memory bank mounted to the target device may be read by means of the MXC. According to the size of different areas of the designated memory bank, the memory size in the read SPD information of the designated memory bank may be updated and written into the configuration space register of the MXC.

The above memory size in the read SPD information of the designated memory bank before the update may be the memory size of the designated memory bank. The update of the memory size in the read SPD information of the designated memory bank may be an update performed according to different areas in the designated memory bank that respectively store the SPD information corresponding to each host-side server in the group of host-side servers.

For example, in a case where different partitions of the same DIMM have different size, the memory size in the SPD information read by means of the MXC is a total value, but when the MXC reports the SPD information, it may modify the memory size in the SPD information according to the condition of each partition.

Through the embodiments of the present disclosure, the MXC may modify the memory size of the read SPD information according to the partition condition of the mounted memory bank, so that the reported SPD information may be more accurate without adding other analysis operations.

The method for reporting asset information in the embodiments of the present disclosure is explained below in conjunction with an optional example. In some embodiments of the present disclosure, a target device is a CXL device.

The present optional example provides a method for reporting asset information based on CXL memory expansion. By defining a configuration space register for storing SPD information of a DIMM in an MXC, after the MXC is powered on, the SPD information of the DIMM is filled into its own configuration space register, and after waiting for a CPU to be powered on, a BIOS may directly acquire the corresponding SPD information from the configuration space register of the MXC, thereby achieving in-band asset information reporting of a CXL memory expansion device, which is helpful for fault location in future application scenarios with large memory pools.

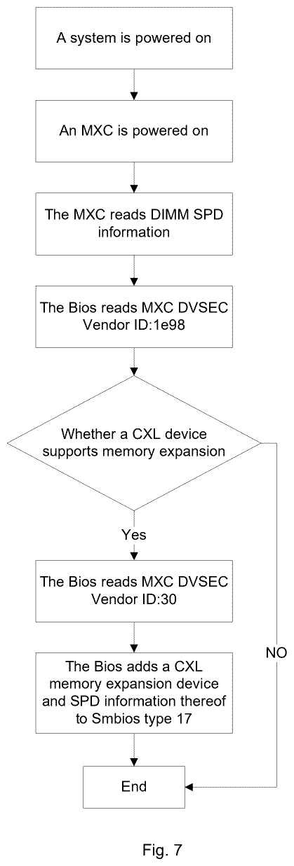

The flow of the method for reporting asset information in some embodiments of the present disclosure may be as shown in FIG. 7, and may include the following steps.

At S1, a system is powered on.

At S2, the MXC is powered on.

At S3, the MXC reads the SPD information of the DIMM by means of an I2C and stores same in its own DVSEC space.

At S4, a BIOS reads information in a register space of DVSEC Vendor ID: 1e98h.

At S5, it is determined whether the CXL device has memory expansion capability according to the read information.

At S6, in response to the CXL device supporting memory expansion, the corresponding register (such as DVSEC Vendor ID: 30) is read to acquire the SPD information.

At S7, the read SPD information of the CXL device is add to Smbios type 17. as a system asset information list for reporting.

Through the embodiments of the present disclosure, the problem that the asset information of the current CXL device needs to be acquired by means of the BMC is solved, so that the asset information of the CXL device may be reported as the asset information like the normal DIMM.

It is to be noted that, for simple description, each of the abovementioned method embodiments is expressed as a combination of a series of operations, but those skilled in the art should know that the present disclosure is not limited to the described operation sequence because some steps may be executed in other sequences or at the same time according to the present disclosure. Second, those skilled in the art should also know that all the embodiments described in the specification are optional embodiments and involved operations and modules are not always required by the present disclosure.

By means of the above description of implementations, those skilled in the art may clearly know that the method according to the above embodiments may be implemented by means of software plus a necessary common hardware platform, certainly by means of hardware; but in many cases, the former is the better implementation. Based on such understanding, the technical solution of the embodiments of the present disclosure, which is essential or contributes to the conventional art, may be embodied in the form of a software product. The computer software product is stored in a non-volatile readable storage medium (such as a Read-Only Memory (ROM)/RAM, a magnetic disk and an optical disc), including a number of instructions for causing a terminal device (which may be a mobile phone, a computer, a server, or a network device, etc.) to perform the methods described in various embodiments of the present disclosure.

According to still another aspect of the embodiments of the present disclosure, an apparatus for reporting asset information is further provided. The apparatus is configured to implement the asset information reporting method provided in the above embodiments. The method for reporting asset information that has been elaborated will not be repeated here. The term “module” used below can realize a combination of software and/or hardware with an intended function. Although the apparatus described in the following embodiments is preferably realized by software, but by hardware or a combination of software and hardware is also possible and conceived.

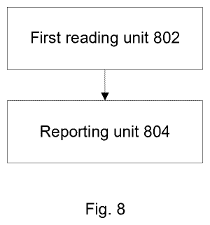

FIG. 8 is a structural block diagram of an apparatus for reporting asset information according to embodiments of the present disclosure. As shown in FIG. 8, the apparatus includes a first reading unit 802 and a reporting unit 804.

The first reading unit 802 is configured to read, in a case where a target device supports memory expansion, SPD information of a designated memory bank mounted to the target device from a configuration space register of an MXC of the target device by means of a BIOS, where the target device is a device that supports a CXL protocol, which is an open interconnection standard.

The reporting unit 804 is configured to report, in a case where target SPD information has been read, the target SPD information to a CPU of the target device as system asset information by means of the BIOS.

Through the embodiments of the present disclosure, in a case where the target device supports memory expansion, the SPD information of the designated memory bank mounted to the target device is read from the configuration space register of the MXC of the target device by means of the BIOS, where the target device is the device that supports the CXL protocol, which is the open interconnection standard; and in a case where the target SPD information has been read, the target SPD information is reported to the CPU of the target device as the system asset information by means of the BIOS, thereby solving the problem of low reporting efficiency of the asset information due to out-of-band access in the method for reporting asset information in the related art and improving the reporting efficiency of the asset information.

In some embodiments of the present disclosure, the reporting unit includes an adding module.

The adding module is configured to add, in a case where the target SPD information has been read, the target SPD information to a designated data structure of the BIOS by means of the BIOS, so as to report the target SPD information to the CPU of the target device as the system asset information of the BIOS, where the designated data structure is a data structure for reporting the system asset information.

In some embodiments of the present disclosure, the first reading module includes an access module.

The access module is configured to access, in a case where the target device supports memory expansion, the configuration space register of the MXC by the BIOS in a memory map manner, so as to read the SPD information of the designated memory bank mounted to the target device from the configuration space register of the MXC.

In some embodiments of the present disclosure, the above apparatus further includes a second reading unit and a writing unit.

The second reading unit is configured to read, after the MXC is powered on, the SPD information of the designated memory bank mounted to the target device by means of the MXC.

The writing unit is configured to write the read SPD information of the designated memory bank into the configuration space register of the MXC.

In some embodiments of the present disclosure, the configuration space register of the MXC is a DVSEC register. The writing unit includes a first writing module.

The first writing module is configured to write the read SPD information of the designated memory bank into one DVSEC register, where the space size of the DVSEC register is a designated space size.

In some embodiments of the present disclosure, the configuration space register of the MXC is a DVSEC register. The writing unit includes a second writing module.

The second writing module is configured to respectively write sub-SPD information read from each data block in a plurality of data blocks into one DVSEC register, where the SPD information of the designated memory bank is divided into a plurality of pieces of sub-SPD information, and each piece of sub-SPD information in the plurality of pieces of sub-SPD information is respectively stored in each data block in the plurality of data blocks.

In some embodiments of the present disclosure, the above apparatus further includes a first setting unit.

The first setting unit is configured to set, before respectively writing the sub-SPD information read from each data block in the plurality of data blocks into one DVSEC register, the corresponding DVSEC register for each data block according to the space size of each data block, where the space size of the corresponding DVSEC register set for each data block is greater than or equal to the space size of each data block.

In some embodiments of the present disclosure, the above apparatus further includes an execution unit and a second setting unit.

The execution unit is configured to number, before respectively writing the sub-SPD information read from each data block in the plurality of data blocks into one DVSEC register, each data block in the plurality of data blocks.

The second setting unit is configured to set a corresponding register identifier for each data block, where the register identifier corresponding to each data block includes: a first register identifier for identifying a register vendor of the DVSEC register corresponding to each data block, and a second register identifier for identifying the DVSEC register corresponding to each data block, where some identifiers in the second register identifier corresponding to each data block are matched with a number of each data block.

In some embodiments of the present disclosure, the above apparatus further includes a first determination unit and a second comparison unit.

The first determination unit is configured to determine, after reading the SPD information of the designated memory bank mounted to the target device by means of the MXC, a first hash value corresponding to the read SPD information of the designated memory bank.

The comparison unit is configured to compare the first hash value with a second hash value corresponding to the SPD information recorded in the configuration space register of the MXC, where the read SPD information of the designated memory bank is written into the configuration space register of the MXC in a case where the first hash value and the second hash value are inconsistent.

In some embodiments of the present disclosure, the above apparatus further includes a third reading unit and a second determination unit.

The third reading unit is configured to, before reading, in a case where the target device supports memory expansion, the SPD information of the designated memory bank mounted to the target device from the configuration space register of the MXC of the target device by means of the BIOS, read the memory expansion indication information from the specific configuration space register of the MXC of the target device by means of the BIOS, where the specific configuration space register is a configuration space register that records a device type of the target device, and the memory expansion indication information is configured to indicate whether the target device supports memory expansion.

The second determination unit is configured to determine, in a case where the memory expansion indication information indicates that the target device supports memory expansion, that the target device supports memory expansion.

In some embodiments of the present disclosure, the above apparatus further includes a third determination unit.

The third determination unit is configured to, after reading the memory expansion indication information from the specific configuration space register of the MXC of the target device by means of the BIOS, determine, in a case where the memory expansion indication information indicates that the target device does not support memory expansion, that the target device has no SPD information.

In some embodiments of the present disclosure, the above apparatus further includes a starting unit and a fourth reading unit.

The starting unit is configured to start, after reading the SPD information of the designated memory bank mounted to the target device from the configuration space register of the MXC of the target device by means of the BIOS, a timer in a case where the SPD information is not read, where a timing time of the timer is a preset time interval between two adjacent readings of the SPD information of the designated memory bank.

The fourth reading unit is configured to read, in a case where the timing time of the timer arrives, the SPD information of the designated memory bank again from the configuration space register of the MXC by means of the BIOS.

In some embodiments of the present disclosure, the above apparatus further includes a first acquisition unit.

The first acquisition unit is configured to acquire, before reading the SPD information of the designated memory bank mounted to the target device from the configuration space register of the MXC of the target device by means of the BIOS, first bit information corresponding to the SPD information of the designated memory bank from the configuration space register of the MXC, where the first bit information is configured to identify whether the SPD information stored in the configuration space register of the MXC is valid, and the SPD information of the designated memory bank read from the configuration space register of the MXC is executed in a case where the first bit information is configured to identify that the SPD information stored in the configuration space register of the MXC is valid.

In some embodiments of the present disclosure, the designated memory bank is a group of memory banks. The above apparatus further includes a second acquisition unit and a locating unit.

The second acquisition unit is configured to acquire, in a case where a memory fault occurs, fault indication information corresponding to the group of memory banks from the configuration space register of the MXC, where the fault indication information corresponding to the group of memory banks is configured to indicate whether each memory bank in the group of memory banks fails.

The locating unit is configured to perform fault location according to the fault indication information corresponding to the group of memory banks, so as to locate the failed memory bank in the group of memory banks.

In some embodiments of the present disclosure, the second acquisition unit module includes an acquisition module.

The acquisition module is configured to acquire, in a case where the memory fault occurs, second bit information corresponding to each memory bank in the group of memory banks from the configuration space register of the MXC, where the second bit information corresponding to each memory bank is configured to indicate whether each memory bank fails.

In some embodiments of the present disclosure, the above apparatus further includes a storage unit.

The storage unit is configured to respectively store, in a case where the MXC is connected to a group of host-side servers, the SPD information corresponding to each host-side server in the group of host-side servers in different areas of one designated memory bank.

In some embodiments of the present disclosure, the above apparatus further includes a fifth reading unit and an update unit.

The fifth reading unit is configured to read, after respectively storing the SPD information corresponding to each host-side server in the group of host-side servers in different areas of one designated memory bank, the SPD information of the designated memory bank mounted to the target device by means of the MXC after the MXC is powered on.

The update unit is configured to update, according to the size of different areas of the designated memory bank, the memory size in the read SPD information of the designated memory bank, and write the updated memory size into the configuration space register of the MXC, where the memory size in the read SPD information of the designated memory bank before the update is the memory size of the designated memory bank.

It is to be noted that, each of the above modules may be realized by software or hardware. For the latter, the each of the above modules may be realized by, but is not limited to, the following way: all of the above modules are in the same processor; or, the above modules are respectively in different processors in form of any combination.

According to still another aspect of the embodiments of the present disclosure, a computer non-transitory readable storage medium is further provided, in which a computer program is stored. The computer program is configured to execute steps in any one of the above method embodiments when running.

In some embodiments of the present disclosure, the above computer non-volatile computer readable storage medium may include, but is not limited to, a U disk, an ROM, an RAM, a mobile hard disk, a magnetic disk, a compact disc, and other media capable of storing the computer program.

According to still another aspect of the embodiments of the present disclosure, an electronic device is further provided, which includes a memory and a processor. A computer program is stored in the memory, and the processor is configured to run the computer program to execute steps in any one of the above method embodiments.

In some embodiments of the present disclosure, the above electronic device may further include a transmission device and an input/output device. The transmission device is connected with the above processor, and the input/output device is connected with the above processor.

The optional examples in the embodiments of the present disclosure may refer to the above embodiments and the examples described in the optional implementations, which will not be elaborated herein.

It is apparent that those skilled in the art should appreciate that the above modules and steps of the embodiments of the present disclosure may be implemented by a general-purpose computing apparatus, and they may be centralized in a single computing apparatus or distributed on a network composed of multiple computing apparatuses; they may be implemented by a program code which is capable of being executed by the computing apparatus, so that they may be stored in a storage apparatus and executed by the computing apparatus; and in some situations, the presented or described steps may be executed in an order different from that described here; or they are made into integrated circuit modules, respectively; or multiple modules and steps of them are made into a single integrated circuit module to realize. Thus, the embodiments of the present disclosure are not limited to any particular combination of hardware and software.

The above is only the optional embodiments of the present disclosure, and is not intended to limit the embodiments of the present disclosure, and for those of ordinary skill in the art, various modifications and change may be made to the embodiments of the present disclosure. Any modifications, equivalent substitutions, improvements, etc. made within the principle of the embodiments of the present disclosure shall be included in the scope of protection of the embodiments of the present disclosure.

1. A method for reporting asset information, comprising:
reading, in response to a target device supporting memory expansion, Serial Presence Detect (SPD) information of a designated memory bank mounted to the target device from a configuration space register of a Memory Expander Controller (MXC) of the target device by means of a Basic Input Output System (BIOS), wherein the target device is a device that supports a Computer Express Link (CXL) protocol, which is an open interconnection standard; and
reporting, in response to target SPD information having been read, the target SPD information to a Central Processing Unit (CPU) of the target device as system asset information by means of the BIOS.

2. The method as claimed in claim 1, wherein the reading, in response to the target device supporting memory expansion, SPD information of the designated memory bank mounted to the target device from the configuration space register of the MXC of the target device by means of the BIOS comprises:
accessing, in response to the target device supporting memory expansion, the configuration space register of the MXC by the BIOS in a memory map manner, so as to read the SPD information of the designated memory bank mounted to the target device from the configuration space register of the MXC.

3. The method as claimed in claim 1, wherein the reporting, in response to target SPD information having been read, the target SPD information to the CPU of the target device as system asset information by means of the BIOS comprises:
adding, in response to the target SPD information having been read, the target SPD information to a designated data structure of the BIOS by means of the BIOS, so as to report the target SPD information to the CPU of the target device as the system asset information of the BIOS, wherein the designated data structure is a data structure for reporting the system asset information.

4. The method as claimed in claim 1, wherein before reading, in response to the target device supporting memory expansion, the SPD information of the designated memory bank mounted to the target device from the configuration space register of the MXC of the target device by means of the BIOS, the method further comprises:
reading, after the MXC is powered on, the SPD information of the designated memory bank mounted to the target device by means of the MXC; and
writing the read SPD information of the designated memory bank into the configuration space register of the MXC.

5. The method as claimed in claim 4, wherein the configuration space register of the MXC comprises:
a Designated Vendor-Specific Extended Capability (DVSEC) register; and the writing the read SPD information of the designated memory bank into the configuration space register of the MXC comprises:
writing the read SPD information of the designated memory bank into one DVSEC register, wherein the space size of the DVSEC register is a designated space size.

6. The method as claimed in claim 4, wherein the configuration space register of the MXC comprises: a DVSEC register; and the writing the read SPD information of the designated memory bank into the configuration space register of the MXC further comprises:
respectively writing sub-SPD information read from each data block in a plurality of data blocks into one DVSEC register, wherein the SPD information of the designated memory bank is divided into a plurality of pieces of sub-SPD information, and each piece of sub-SPD information in the plurality of pieces of sub-SPD information is respectively stored in each data block in the plurality of data blocks.

7. The method as claimed in claim 6, wherein before respectively writing the sub-SPD information read from each data block in the plurality of data blocks into one DVSEC register, the method further comprises:
setting the corresponding DVSEC register for each data block according to the space size of each data block, wherein the space size of the corresponding DVSEC register set for each data block is greater than or equal to the space size of each data block.

8. The method as claimed in claim 6, wherein before respectively writing the sub-SPD information read from each data block in the plurality of data blocks into one DVSEC register, the method further comprises:
numbering each data block in the plurality of data blocks; and
setting a corresponding register identifier for each data block, wherein the register identifier corresponding to each data block comprises: a first register identifier for identifying a register vendor of the DVSEC register corresponding to each data block, and a second register identifier for identifying the DVSEC register corresponding to each data block, wherein some identifiers in the second register identifier corresponding to each data block are matched with a number of each data block.

9. The method as claimed in claim 4, wherein after reading the SPD information of the designated memory bank mounted to the target device by means of the MXC, the method further comprises:
determining a first hash value corresponding to the read SPD information of the designated memory bank; and
comparing the first hash value with a second hash value corresponding to the SPD information recorded in the configuration space register of the MXC, wherein the read SPD information of the designated memory bank is written into the configuration space register of the MXC in response to the first hash value and the second hash value being inconsistent.

10. The method as claimed in claim 1, wherein before reading, in response to the target device supporting memory expansion, the SPD information of the designated memory bank mounted to the target device from the configuration space register of the MXC of the target device by means of the BIOS, the method further comprises:
reading memory expansion indication information from a specific configuration space register of the MXC of the target device by means of the BIOS, wherein the specific configuration space register is a configuration space register that records a device type of the target device, and the memory expansion indication information is configured to indicate whether the target device supports memory expansion; and
determining, in response to the memory expansion indication information indicating that the target device supports memory expansion, that the target device supports memory expansion.

11. The method as claimed in claim 10, wherein after reading the memory expansion indication information from the specific configuration space register of the MXC of the target device by means of the BIOS, the method further comprises:
determining, in response to the memory expansion indication information indicating that the target device does not support memory expansion, that the target device has no SPD information.

12. The method as claimed in claim 1, wherein after reading the SPD information of the designated memory bank mounted to the target device from the configuration space register of the MXC of the target device by means of the BIOS, the method further comprises:
starting a timer in response to the SPD information being not read, wherein a timing time of the timer is a preset time interval between two adjacent readings of the SPD information of the designated memory bank; and
reading, in response to the timing time of the timer arriving, the SPD information of the designated memory bank again from the configuration space register of the MXC by means of the BIOS.

13. The method as claimed in claim 1, wherein before reading the SPD information of the designated memory bank mounted to the target device from the configuration space register of the MXC of the target device by means of the BIOS, the method further comprises:
acquiring first bit information corresponding to the SPD information of the designated memory bank from the configuration space register of the MXC, wherein the first bit information is configured to identify whether the SPD information stored in the configuration space register of the MXC is valid, and the SPD information of the designated memory bank read from the configuration space register of the MXC is executed in response to the first bit information being configured to identify that the SPD information stored in the configuration space register of the MXC is valid.

14. The method as claimed in claim 1, wherein the designated memory bank is a group of memory banks; and the method further comprises:
acquiring, in response to a memory fault occurring, fault indication information corresponding to the group of memory banks from the configuration space register of the MXC, wherein the fault indication information corresponding to the group of memory banks is configured to indicate whether each memory bank in the group of memory banks fails; and
performing fault location according to the fault indication information corresponding to the group of memory banks, so as to locate the failed memory bank in the group of memory banks.

15. The method as claimed in claim 14, wherein the acquiring, in response to the memory fault occurring, the fault indication information corresponding to the group of memory banks from the configuration space register of the MXC comprises:
acquiring, in response to the memory fault occurring, second bit information corresponding to each memory bank in the group of memory banks from the configuration space register of the MXC, wherein the second bit information corresponding to each memory bank is configured to indicate whether each memory bank fails.

16. The method as claimed in claim 1, further comprising:
respectively storing, in response to the MXC being connected to a group of host-side servers, the SPD information corresponding to each host-side server in the group of host-side servers in different areas of one designated memory bank.

17. The method as claimed in claim 16, wherein after respectively storing the SPD information corresponding to each host-side server in the group of host-side servers in different areas of one designated memory bank, the method further comprises:
reading, after the MXC is powered on, the SPD information of the designated memory bank mounted to the target device by means of the MXC; and
updating, according to the size of different areas of the designated memory bank, the memory size in the read SPD information of the designated memory bank, and writing the updated memory size into the configuration space register of the MXC, wherein the memory size in the read SPD information of the designated memory bank before the update is the memory size of the designated memory bank.

18. (canceled)

19. A non-transitory computer readable storage medium, in which a computer program is stored, wherein the computer program is executed by a processor, cause the processor to:
read, in response to a target device supporting memory expansion, Serial Presence Detect (SPD) information of a designated memory bank mounted to the target device from a configuration space register of a Memory Expander Controller (MXC) of the target device by means of a Basic Input Output System (BIOS), wherein the target device is a device that supports a Computer Express Link (CXL) protocol, which is an open interconnection standard; and
report, in response to target SPD information having been read, the target SPD information to a Central Processing Unit (CPU) of the target device as system asset information by means of the BIOS.

20. An electronic device, comprising a memory, a processor, and a computer program stored in the memory and runnable on the processor, wherein the processor is configured to execute the computer program to:
read, in response to a target device supporting memory expansion, Serial Presence Detect (SPD) information of a designated memory bank mounted to the target device from a configuration space register of a Memory Expander Controller (MXC) of the target device by means of a Basic Input Output System (BIOS), wherein the target device is a device that supports a Computer Express Link (CXL) protocol, which is an open interconnection standard; and
report, in response to target SPD information having been read, the target SPD information to a Central Processing Unit (CPU) of the target device as system asset information by means of the BIOS.

21. The method as claimed in claim 1, wherein the configuration space register of the MXC comprises a configuration space register in the MXC that is only configured to store the SPD information, and the configuration space register is one register or a group of registers.
